(19) United States
(12) Patent Application Publication
(10) Pub. No.: US 2003/0228066 A1
(43) Pub. Date: Dec. 11, 2003

(54) Image data processing unit for use in a visual inspection device

(75) Inventors: Yasushi Tomita, Tokyo (JP); Masahiko Nagao, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/452,716

(22) Filed: Jun. 3, 2003

(30) Foreign Application Priority Data
Jun. 11, 2002 (JP) 2002-169653
Mar. 11, 2003 (JP) 2003-65720

(51) Int. Cl. G06K 9/40

(52) U.S. Cl. 382/274; 382/190

(57) ABSTRACT

An image data processing unit in a visual inspection device includes a central area data extractor tracing two-dimensional image data to extract a average central brightness, a peripheral area data extractor tracing the two-dimensional image data to extract average central brightness data, a difference calculator for calculating differences between the central brightness data and the peripheral brightness data to create emphasized two-dimensional image data, and an unevenness detection section for detecting an uneven area in the two-dimensional image data based on the emphasized two-dimensional image data.

### BACKGROUND OF THE INVENTION

(a) Field of the Invention

The present invention relates to an image data processing unit for use in a visual inspection device and, more particularly, to an image data processing unit for use in a visual inspection device, which is capable of testing the evenness of brightness in an object pattern. The present invention also relates to a method for processing two-dimensional image data.

(b) Description of the Related Art

In general, the screen of a product LCD unit is tested by using a visual inspection device, which assures the evenness of brightness of the image on the screen. FIG. 28 shows a conventional visual inspection device for testing the screen of a LCD unit including a LCD panel 82 and a backlight 80 for irradiating the LCD panel 82 from the rear side thereof. The visual inspection device includes a camera 84, such as a CCD camera, for generating image data, and an image data processing unit 90 receiving the image data from the camera 84 for image data processing. During testing the LCD unit by using the visual inspection device, the backlight 80 is turned on by using a pair of probing pins 83.

The image data processing unit 90 includes an A/D converter 91, a processor 92, a memory 93 and an indicator 94. The image data processing unit 90 receives the image data from the camera 84, separates the image data into a plurality of lattice areas, calculates an average of data of each lattice area, and calculates the amount and rate of change in the average with respect to a specified reference value, thereby testing the evenness of the brightness on the screen of the LCD unit.

Patent Publication JP-A-11-136659 describes a technique for correcting a defect in the image data. This technique includes the step of extracting the brightness data, i.e., gray-scale data of each pixel from the image data obtained by imaging an object pattern, and comparing the brightness of a noticed group of pixels (subject data) against the brightness of a group of peripheral pixels (peripheral data), both selected for this purpose from the background of the image data to detect unevenness of the brightness in the image data, thereby correcting the unevenness existing in the image data. The term “central area” as used in this text means an area including the pixel for which birghtness data is to be extracted, and the term “peripheral area” means an area disposed adjacent to the central area with a gap or without a gap therebetween, and the peripheral area preferably has at least a pair of sections disposed in symmetry with each other with respect to the pixel in the central area.

The image data obtained by using a camera may have unevenness including high-frequency noise and/or a low-frequency change of brightness, wherein the shape and/or size of the unevenness differs depending on the image data. The conventional technique as mentioned above does not notice such a difference in the image data. For example, if it is desired that unevenness be detected in the image data wherein only a small difference exists between the brightness of the subject data and the brightness of the peripheral data in the image data, or in other words, if a minor unevenness of the brightness is to be detected in the lattice areas having high-frequency noise therein, then a significant difference cannot be detected in the image data. Thus, the unevenness is in fact difficult to detect depending on the background of the image data and the shape and/or size of the unevenness.

### SUMMARY OF THE INVENTION

In view of the above, it is an object of the present invention to provide an image data processing unit for use in a visual inspection device, which is capable of accurately and stably inspecting unevenness of the image data by emphasizing the image data of an uneven area depending on the background of the image data and the shape and size of the unevenness.

The present invention provides a image data processing unit including: a central area data extractor for tracing two-dimensional imaged data to consecutively extract brightness of a plurality of pixels in a central area specified by a central area pattern and to obtain central brightness data: a peripheral area data extractor for tracing the two-dimensional image data to consecutively extract brightness of a plurality of pixels in a peripheral area specified by a peripheral area pattern and to obtain peripheral brightness data, the peripheral area being juxtaposed with the central area in the two-dimensional image data; a difference calculator for calculating difference data between the central brightness data and the corresponding peripheral brightness data to thereby obtain emphasized two-dimensional image data; and an unevenness detection section for detecting an uneven area in the two-dimensional image data based on the emphasized two-dimensional image data.

The present invention also provides a method for processing two-dimensional image data, including the steps of; tracing the two-dimensional imaged data to consecutively extract brightness of a plurality of pixels in a central area specified by a central area pattern and obtain central brightness data: tracing the two-dimensional image data to consecutively extract brightness of a plurality of pixels in a peripheral area specified by a peripheral area pattern and obtain peripheral brightness data, the peripheral area being juxtaposed with the central area in the two-dimensional image data; calculating difference data between the central brightness data and the corresponding peripheral brightness data to thereby obtain emphasized two-dimensional image data; and detecting an uneven area in the two-dimensional image data based on the emphasized two-dimensional image data.

In accordance with the visual inspection device and the method of the present invention, the emphasized two-dimensional image data obtained from the original two-dimensional image data by calculating the difference data between the average central area data and the average peripheral area data allows accurate and stable detection of the uneven area in the two-dimensional image data.

The above and other objects, features and advantages of the present invention will be more apparent from the following description, referring to the accompanying drawings.

### BRIEF DESCRIPTION OF THE DRAWINGS

FIG. 1 is a schematic block diagram of a visual inspection device including an image data processing unit according to a first embodiment of the present invention.

FIG. 2 is a functional block diagram of the image processing unit shown in FIG. 1.

FIGS. 3A and 3B are diagrams showing examples of area patterns stored in the central and peripheral area pattern memories, respectively.

FIGS. 4A, 4B and 4C are diagrams showing examples of combinational patterns specified by the area pattern selector shown in FIG. 2.

FIG. 5 is an explanatory diagram showing the tracing extraction process on the two-dimensional image data by using the combinational pattern including central and peripheral area patterns.

FIG. 6 is a flowchart of operation of the image data processing unit of FIG. 2.

FIGS. 7A, 7B and 7C are a top plan view of the original two-dimensional image data, a graph showing a profile of brightness on the line L in FIG. 7A, and a graph showing a conventional technique for detecting a candidate uneven area in FIG. 7B, respectively.

FIG. 8 is a combinational pattern diagram set by the area pattern selector shown in FIG. 2.

FIG. 9 is a graph showing extraction of image brightness data from the two-dimensional image data in the present embodiment by using the combinational pattern.

FIG. 10 is an explanatory graph for comparison between line data of the two-dimensional image data and line data of the emphasized two-dimensional image data.

FIGS. 11A, 11B and 11C are a top plan view of the original two-dimensional image data, a graph showing unevenness having high-frequency brightness change and a graph showing conventional technique for separation of the areas shown in FIG. 7B, respectively.

FIG. 12 is an explanatory diagram showing extraction of image brightness data from the two-dimensional data in the present embodiment.

FIG. 13 is an explanatory diagram showing comparison between line data of the two-dimensional data having high-frequency noise and line data of emphasized two-dimensional image data.

FIG. 14 is a table tabulating gray levels representing the brightness of the two-dimensional image data including an uneven area.

FIG. 15 is a table obtained by quantizing the gray-levels shown in FIG. 14 in a conventional technique using a fixed threshold.

FIG. 16 is an exemplified pattern diagram of a combinational pattern including a square central area pattern and a peripheral area pattern surrounding the central area pattern.

FIG. 17 is a table tabulating brightness of the emphasized two-dimensional image data obtained from the two-dimensional image data shown in FIG. 14.

FIGS. 18A and 18B are explanatory diagrams each showing example of area setting by the area pattern selector shown in FIG. 2 for emphasis of unevenness in the image data.

FIG. 19 is a graph showing the profile of the brightness in the line data of the two-dimensional image data having dark unevenness.

FIG. 20 is a functional block diagram of an image data processing unit according to a second embodiment of the present invention.

FIGS. 21A and 21B are explanatory diagrams each showing the quantizing approximation processing by the area pattern composer shown in FIG. 20.

FIG. 22 is an exemplified pattern diagram of a combinational pattern including the central area pattern shown in FIG. 21B.

FIG. 23 is a functional block diagram of an image data processing unit according to a third embodiment of the present invention.

FIGS. 24A, 24B and 24C are explanatory diagrams each showing selection of the combinational pattern by the area pattern selector shown in FIG. 23 based on the uneven area to be detected.

FIG. 25 is a functional block diagram of an image data processing unit according to a fourth embodiment of the present invention.

FIGS. 26A, 26B and 26C are explanatory diagrams each showing processing by the image data processing unit of FIG. 25.

FIG. 27 is a flowchart of processing by an image data processing unit according to a fifth embodiment of the present invention.

FIG. 28 is a block diagram of a conventional visual inspection device.

FIG. 29 is a diagram of a combinational pattern including a gap between a central area pattern and a peripheral area pattern.

FIG. 30 is another diagram a combinational pattern including a gap between a central area pattern and a peripheral area pattern.

### PREFERRED EMBODIMENTS OF THE INVENTION

Now, the present invention is more specifically described with reference to accompanying drawings, wherein similar constituent elements are designated by similar reference numerals.

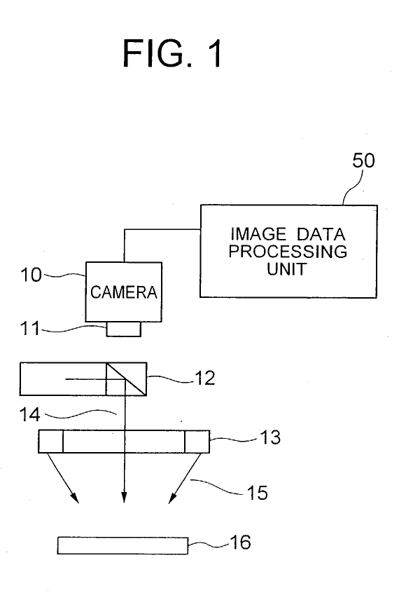

Referring to FIG. 1, a visual inspection device including an image data processing unit according to a first embodiment of the present invention includes a camera 10 having an objective lens 11 for imaging an object pattern 16, a main lighting device 12, an auxiliary lighting device 13, and the image data processing unit 50 for processing the image signal obtained by the camera 10. The object pattern 16 is formed on the screen of a flat display panel such as a LCD unit or plasma display unit.

The main lighting device 12 emits co-axial light 14 co-axially irradiating the object pattern 16 from above, whereas the auxiliary lighting device 12 emits oblique light 15 obliquely irradiating the object pattern 16 from above. These lighting devices 12 and/or 13 may be omitted if the object pattern 16 is formed on the screen of a LCD unit or a monitor having a backlight unit.

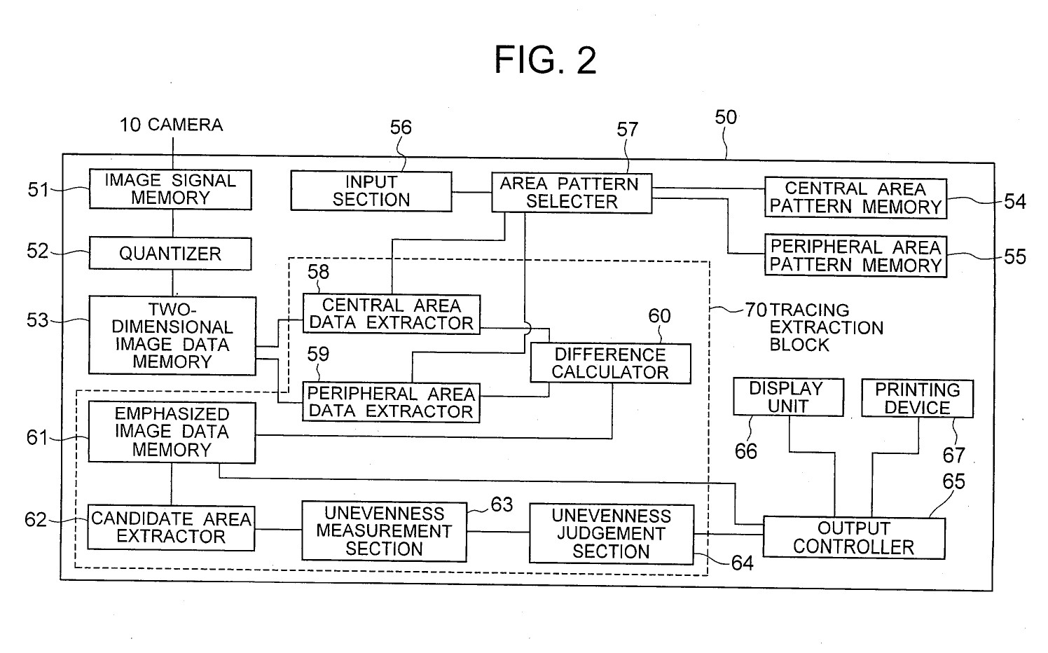

Referring to FIG. 2, the image data processing unit 50 includes image signal memory 51, quantizer 52, two-dimensional image data memory 53, central area pattern memory 54, peripheral area pattern memory 55, input section 56, area pattern selector 57, tracing extraction block 70, output controller 65, display unit 66 and printing device 67. The tracing extraction block 70 includes a central area data extractor 58, a peripheral area data extractor 59, a subtractor 60, an emphasized image data memory 61, candidate area extractor 62, unevenness measurement section 63, and unevenness judgement section 64. The candidate area extractor 62, unevenness measurement section 63 and unevenness judgement section 64 constitute an uneven area detector.

The image signal memory 51 stores therein the image signal obtained by the camera 10 from the object pattern 16. The two-dimensional image data memory 53 stores therein original two- dimensional image data converted from the image signal by the quantizer 52. It is preferable that image data memory 51 and the two-dimensional image data memory 53 be implemented by a common frame memory or image memory.

The quantizer 52 operates based on a program, quantizes the image signal stored in the image signal memory 51 to convert the image signal into the two-dimensional image data, and stores the two-dimensional image data in the two-dimensional image data memory.

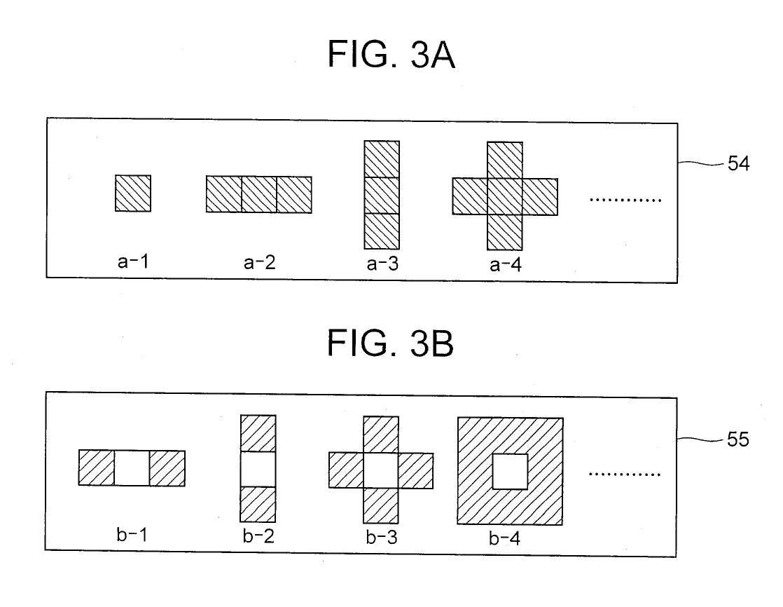

The central area pattern memory 54 stores therein a plurality of central area patterns each of which is used to specify an area (central area) in the two-dimensional image data for extracting therefrom image brightness data, the image brightness data being used for emphasizing unevenness in the image data to obtain emphasized image data. The central area patterns stored in the central area pattern memory 54 are exemplified in FIG. 3A, wherein each square shown represents a pixel.

The peripheral area pattern memory 55 stores therein a plurality of peripheral area patterns each of which is used to specify a peripheral area in the two-dimensional image data for extracting therefrom the image brightness data in combination with the central area pattern. The peripheral area patterns stored in the peripheral area pattern memory 55 are exemplified in FIG. 3B, wherein the blank pattern (blank pixel) within the peripheral area pattern represents the location of the corresponding central area pattern.

The area pattern selector 57 operates on a program and determines one of the central area patterns stored in the central area pattern memory 54 and one of the peripheral area patterns stored in the peripheral area pattern memory 55 based on the selection instruction input through the input section 56 such as a keyboard. The area pattern selector 57 also determines sizes of the central and peripheral area patterns. The central area pattern and the peripheral area pattern thus specified in combination form a combinational pattern to be used for tracing the two-dimensional image data during extraction of the brightness data therefrom. The selection instruction is input by an operator through the input section 56, specifying the central and peripheral area patterns displayed on the display unit 66, and the sizes of the central and peripheral area patterns.

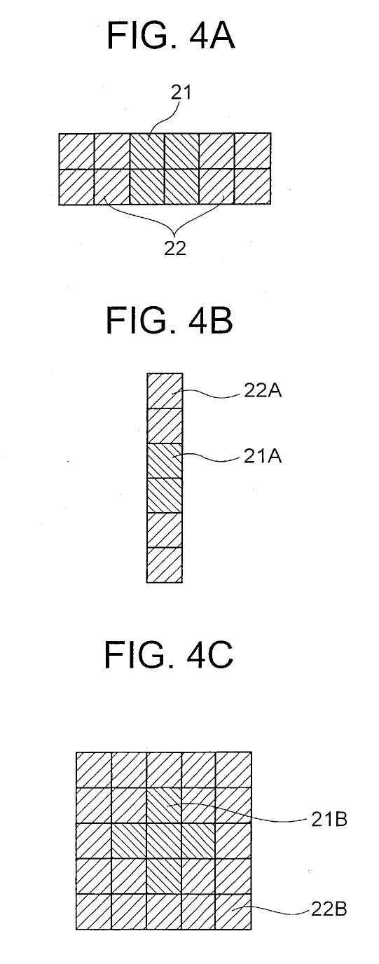

For example, if the central area pattern denoted by “a-1” among the patterns shown in FIG. 3A is specified together with specification of a 2×2 pixel size and if the peripheral area pattern denoted by “b-1” among the patterns shown in FIG. 3B is specified together with specification of a 2-pixel size, then the resultant combinational pattern including the central area pattern 21 and the peripheral area pattern 22 as shown in FIG. 4A is obtained. This combinational pattern specifies, during tracing the two-dimensional image data, a central area having a 2×2 pixel size by the central area pattern 21, and a peripheral area having a 2-pixel size on both sides of the central area by the a peripheral area pattern 22.

In another example, if the central area pattern denoted by “a-3” among the patterns shown in FIG. 3A is specified together with specification of a 2-pixel size and if the peripheral area pattern denoted by “b-2” among the patterns shown in FIG. 3B is specified together with specification of 2-pixel size, then the resultant pattern shown in FIG. 4B is obtained. This combinational pattern specifies a central area of a rectangle having a longitudinal 2-pixel size by the central area pattern 21A, and a peripheral area having a longitudinal 2-pixel size on both top and bottom of the central area by the peripheral area pattern 22A.

In a further example, if the central area pattern denoted by “a-4” among the patterns shown in FIG. 3A is specified together with specification of a 3×3 pixel size and if the peripheral area pattern denoted by “b-4” among the patterns shown in FIG. 3B is specified together with specification of a 1-pixel size, then the resultant pattern shown in FIG. 4C is obtained. This combinational pattern specifies, during tracing the two-dimensional image data, a cross central area having a 3×3 pixel size at the central pixel thereof by the central area pattern 21B, and a square peripheral area having a 5×5 pixel size on the outer periphery thereof and surrounding the central area by the peripheral area pattern 22B.

As exemplified above, the combinational pattern includes the central area pattern and the peripheral area pattern juxtaposed with each other. Selection of the shape and size for the central area pattern matched with the shape and size, respectively, of a candidate uneven area which is desired to be emphasized allows the accuracy in extraction of the uneven area. For example, if it is expected that the uneven area has the shape of a lateral stripe, the central area pattern should be a lateral stripe, whereas if it is expected that the uneven area has the shape of a circle, the central area pattern should be of a circle or similar to a circle.

In addition, it is preferable to use a peripheral area pattern which allows the low-frequency brightness change of the background and high-frequency noise components in the two-dimensional image data to be cancelled or equalized, the peripheral area pattern being disposed adjacent to the central area pattern without overlapping.

The central area data extractor 58 operates on a program and extracts the image brightness data, i.e., the gray levels of the central area corresponding to the central area pattern from the two-dimensional image data stored in the two-dimensional image data memory 53, the central area pattern being selected by the area pattern selector 57. The central area data extractor 58 then calculates a central average brightness by averaging the image brightness of pixels in the central area thus extracted.

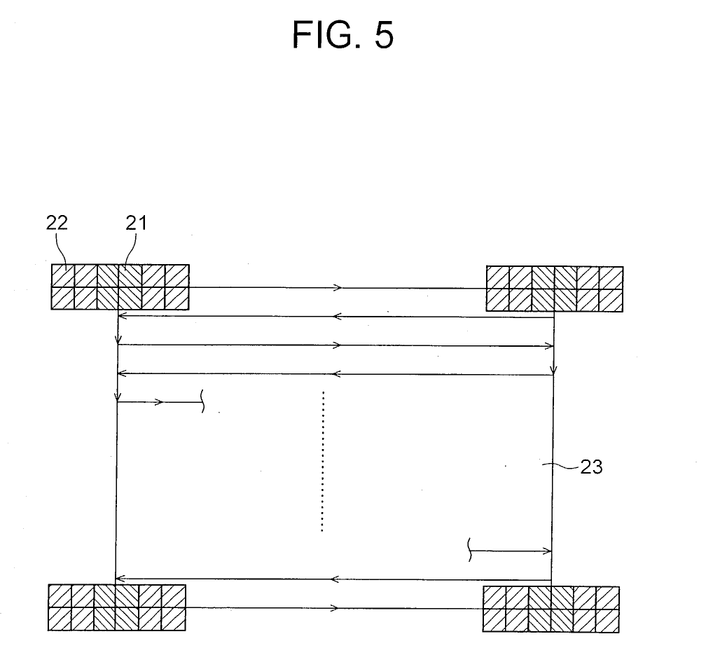

Referring to FIG. 5, tracing extraction of the image brightness of the central area starts at the state wherein the lower right pixel of the central area pattern 21 resides at the pixel of the top left corner of the two-dimensional image data 23, continues while advancing pixel by pixel toward the right, lowers the location by one pixel upon reaching the rightmost edge of the two-dimensional image data 23, continues while advancing pixel by pixel toward the left, lowers the location by one pixel upon reaching the leftmost edge of the two-dimensional image data 23, and continues until the lower right pixel of the central area pattern 21 reaches the pixel of the bottom right corner of the two-dimensional image data 23. Thus, the number of average brightness of the central area obtained by the central area data extractor 58 corresponds to the number of pixels in the two-dimensional image data 23.

The peripheral area data extractor 59 operates on a program and extracts, similarly to the central area data extractor 59, the image brightness data of the peripheral area corresponding to the peripheral area pattern 22 from the two-dimensional image data 23 stored in the two-dimensional image data memory 53, the peripheral area pattern 22 being selected by the area pattern selector 57. The peripheral area data extractor 59 calculates the average peripheral brightness by averaging the image brightness data of the pixels in the peripheral area. The extraction of the image brightness data of the peripheral area by the peripheral area data extractor 59 is conducted concurrently with the extraction of the image brightness data of the central area by the central area data extractor 58. The number of average brightness of the peripheral area correspond to the number of average brightness of the central area in a one-to-one correspondence.

The subtractor 60 operates on a program and calculates a difference between the average central brightness obtained by the central area data extractor 58 for each pixel and the average peripheral brightness obtained by the peripheral area data extractor 59 for the each pixel to create emphasized image data including difference data calculated for respective pixels, storing the emphasized image data in the emphasized imaged data memory 61.

The emphasized image data memory 61 stores therein the emphasized image data obtained by the subtractor 60. It is preferable that the emphasized image data memory 61 be implemented by the common image memory implementing the image signal memory 51 and the two-dimensional image data memory 53. The emphasized image data stored in the emphasized image data memory 61 can be displayed on the display unit 66, and also printed by the printing device 67 as a hard copy.

The candidate area extractor 62 operates on a program and extracts the pixels each having a difference value higher than a predetermined threshold among the emphasized image data stored in the emphasized image data memory 61 to extract a candidate uneven area including the extracted pixels, delivering information of the candidate uneven area to the unevenness measuring section 63. If the candidate area extractor 62 extracts a plurality candidate uneven areas, information of all the extracted candidate uneven areas is delivered to the unevenness measuring section 63.

The unevenness measuring section 63 operates on a program and measures the degrees of unevenness of each candidate uneven area by using a labeling processing, the degrees of unevenness including the size of the candidate uneven area and the magnitude of the difference in the candidate uneven area, for example. The degrees of unevenness of the candidate uneven areas are delivered from the unevenness measuring section 63 to the unevenness judgement section 64.

The unevenness judgement section 64 operates on a program and judges the unevenness of the extracted candidate uneven areas by comparing the degrees of the unevenness of the candidate uneven areas measured by the unevenness measuring section 63 against predetermined thresholds to judge whether or not the candidate uneven area is a true uneven area, allowing the output controller to output the results of judgement through the display unit 66 and/or the printing device 67.

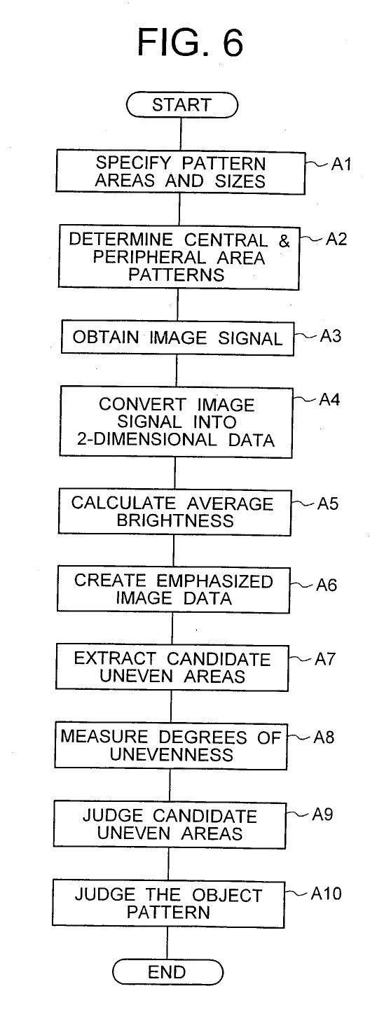

Referring to FIG. 6, there is shown an overall operation of the image data processing unit of FIG. 2. First, an input operation is conducted specifying one of the central area patterns stored in the central area pattern memory 54 and one of the peripheral area patterns stored in the peripheral area pattern memory 55, and specifying the sizes of the specified central and peripheral area patterns (step A1). The area pattern selector 57 responds to the input operation to determine the central area pattern and the peripheral area pattern based on which the image brightness data is to be extracted from the two-dimensional image data during a tracing operation thereof (step A2).

After the object pattern 40 is introduced in the visual inspection device of FIG. 1, the camera 10 takes a picture of the object pattern 40 to deliver an image signal thereof to the image signal memory 51 (step A3). The image signal stored in the image signal memory 51 is then converted into two-dimensional image data including gray levels by the quantizer 52 (step A4). The two-dimensional image data is then stored in the two-dimensional image data memory 53. In an alternative, these steps A3 and A4 may be conducted before the steps A1 and A2. The central area data extractor 58 extracts the gray levels of the central areas each corresponding to the central area pattern from the two-dimensional image data, and calculates the average brightness of the central area by averaging the brightness values of the extracted image brightness data. The peripheral area data extractor 59 extracts brightness values of the image brightness data of the peripheral area specified corresponding to the central area from the two-dimensional image data, and calculates the average brightness for respective pixels (step A5).

The subtractor 60 calculates differences between the average brightness of the central area obtained by the central area data extractor 58 and the respective average brightness of the peripheral area obtained by the peripheral area data extractor 59 to thereby create emphasized image data (step A6), storing the emphasized image data in the emphasized image data memory 61.

The uneven area extractor 62 then extracts candidate uneven areas each having a difference higher than a predetermined threshold from the emphasized image data stored in the emphasized image data memory 61 (step A7), and delivers the quantized image data of the extracted candidate uneven areas to the unevenness measurement section 63. The unevenness measurement section 63 measures the degrees of unevenness including size of the candidate uneven area and the difference therein by using a labeling processing of the extracted candidate uneven area (step A8), outputs the degrees of measured unevenness to the unevenness judgement section 64.

The unevenness judgement section 64 judges whether or not the extracted candidate uneven area is a true uneven area by comparing the degrees of unevenness against specified thresholds (step A9), and delivers the results of judgements to the output controller 65, which controls the display unit 66 and printing device 67 to output the results of judgements as to whether the object pattern is passed or failed (step A10).

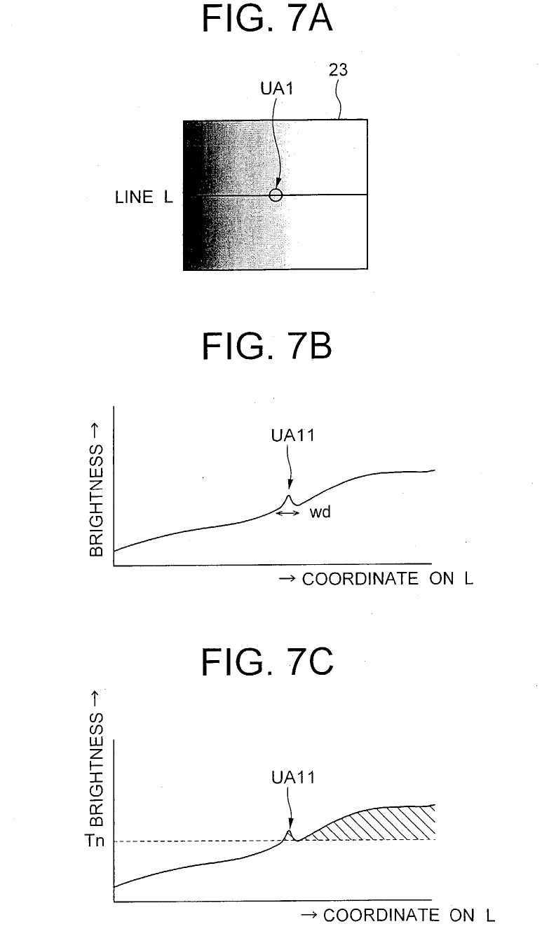

Now, practical examples of the image data processed by the image data processing unit 50 of the first embodiment will be described with reference to FIGS. 7A, 7B, 7C, 8, 9 and 10.

FIG. 7A shows an example of the original two-dimensional image data having therein a low-frequency brightness change, which includes an uneven area UA1 on the line L having y coordinate (L). The uneven area UA1 in the two-dimensional image data obtained from the object pattern generally has an apparent brightness higher or lower than the brightness of the normal areas. In addition, the two-dimensional image data includes a light and shade tone spreading over the whole area of the image data caused by the background of the object pattern and noise caused by the influence of the camera 10.

The profile of brightness values of the image data on the line L is shown in FIG. 7B, wherein the uneven area UA1 causes a projection UA11 on the moderate rising slope of the brightness profile as viewed toward the right. The width Wd of the projection UA1 corresponds to a number of the pixels.

It may be considered to detect the projection UA11 in FIG. 7B by using a fixed threshold. However, if the uneven area UA1 is to be detected by using the threshold Th as illustrated in FIG. 7C, other normal area as well as the projection UA11 having brightness values higher than the threshold Th is detected as an uneven area, which is not suitable.

On the other hand, the image data processing unit 50 in the present embodiment uses the emphasized image data for detecting a candidate uneven area and thus accurately detects the candidate uneven area as detailed below.

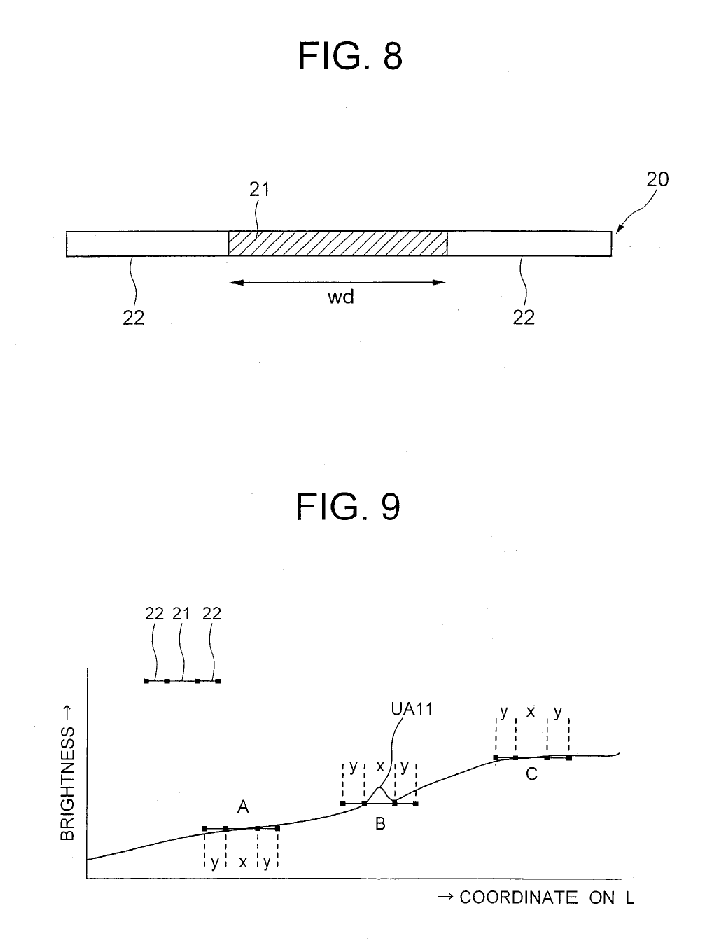

First, the area pattern selector 57 selects the area patterns “a-1” and “b-1” based on the profile shown in FIG. 7B among the central and peripheral area patterns stored in the central and peripheral area pattern memories 54 and 55, respectively, as well as the sizes of the area patterns, thereby specifying a combinational pattern including the central area pattern 21 having a width Wd and the peripheral area pattern 22 as shown in FIG. 8A.

The central area data extractor 58 traces the two-dimensional image data from the top left corner toward the bottom right corner thereof, extracts, for each pixel of the two-dimensional image data, the gray levels of the pixels in the central area corresponding to the central area pattern 21 specified by the area pattern selector 57, calculates an average of the gray levels of the pixels in the central area as the average brightness of the central area (i.e., average central brightness), and delivers the average central brightness corresponding to each pixel to the subtractor 60.

The peripheral area data extractor 59 similarly traces, extracts the gray levels of the pixels in the peripheral area corresponding to the peripheral area pattern 22 specified by the area pattern selector 57, calculates the average brightness of the pixels in the peripheral area, and delivers the average peripheral brightness corresponding to each pixel to the subtractor 60. The subtractor 60 subtracts the average peripheral brightness from the average central brightness corresponding to each pixel to obtain the emphasized two-dimensional image data.

FIG. 9 shows the profile of line data shown in FIG. 7B and the way of the extraction of the brightness values by the first and second pattern extractors 58 and 59 on the line L. In FIG. 9, x corresponds to the central area specified by the central area pattern 21, whereas y corresponds to the peripheral area specified by the peripheral area pattern 22. At the locations A and C, since the profile of line data has a moderate rise in the brightness value and y resides on both sides of x, there is substantially no significant difference between the average brightness of the central area x and the average brightness of the peripheral area y. On the other hand, at the location B where a projection UA11 resides, there is a significant difference between the average brightness of the central area x and the average brightness of the peripheral area y. That is, the brightness value of the central area x is higher than the brightness value of the peripheral area y, whereby the difference in the emphasized image data is higher in the uneven area UA1.

In addition, in the vicinity of the location B, wherein the central area x has therein a portion of the projection UA11, the difference between the average brightness of the central area x and the average brightness of the peripheral area y is higher compared to the difference in the normal area such as locations A and C.

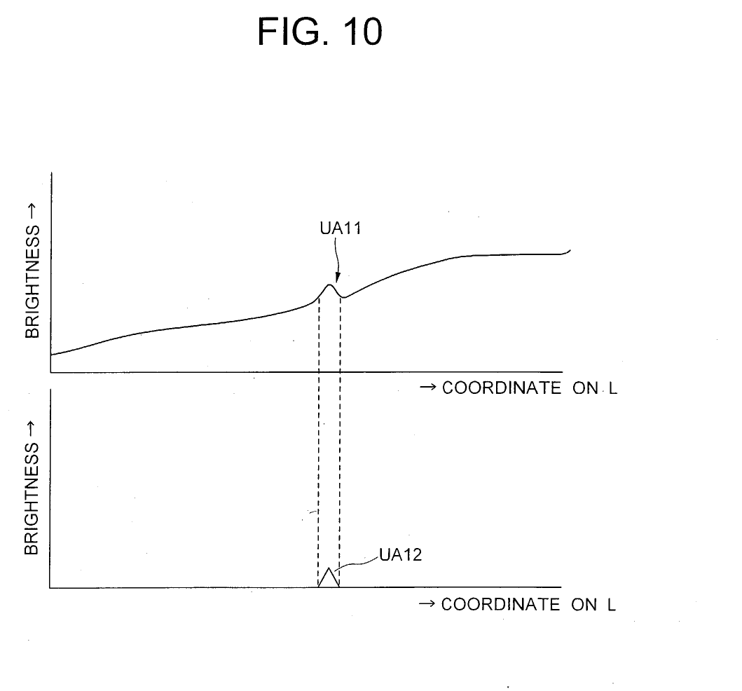

FIG. 10 shows the profile of the original line data including projection UA11 and the profile of the emphasized line data including projection UA12 corresponding to projection UA11. As understood from FIG. 10, the emphasized image data emphasizes the existence of the uneven area UA1 substantially without the influence by the moderate change of the line data having a low-frequency light and shade tone.

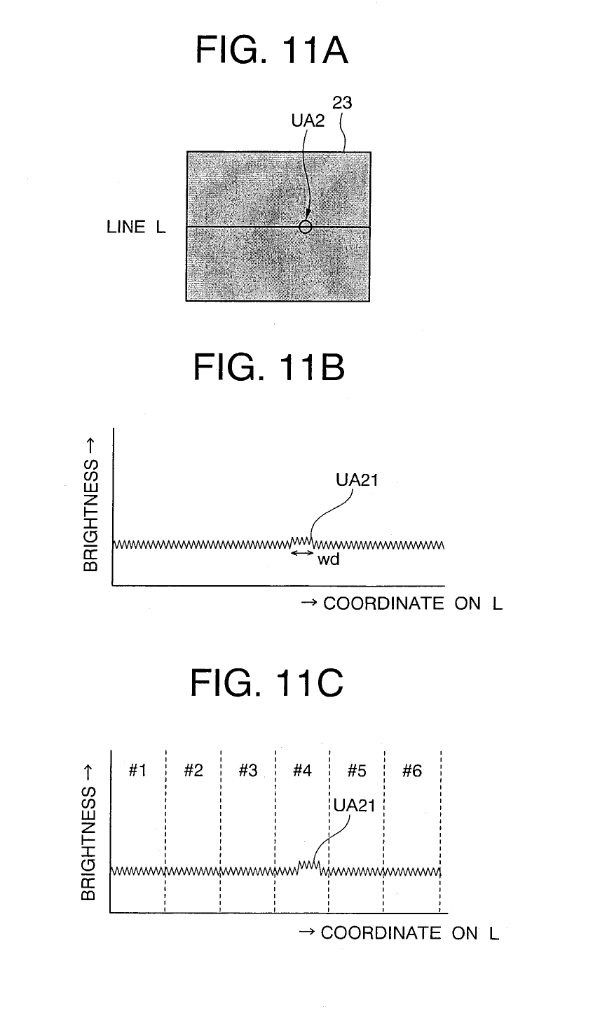

Now, another example of extraction of the uneven area from the two-dimensional image data having therein high-frequency noise will be described. FIG. 11A shows the original two-dimensional image data having high-frequency noise and an uneven area UA2 on the line L, FIG. 11B shows the profile of line data on the line L in FIG. 11A, and FIG. 11C shows the way of conventional technique used for detecting the uneven area from the profile of FIG. 11B.

The camera 10 may cause high-frequency noise in the two-dimensional image data such as shown in FIG. 11A. The profile shown in FIG. 11B has a projection UA21 of a width Wd2 as well as the high-frequency noise, and is generally flat in the total line area except for the projection UA21 and the high-frequency noise.

The conventional technique uses separation of the line data into a plurality of areas having a unit width, and calculates the magnitude and rate of change in average of the brightness in the separate areas, thereby obtaining an uneven area. However, if the projection UA21 in the profile has a width Wd2 smaller compared to the width of the separate areas, the average brightness in the separate area having the projection UA21 does not have a significant difference with respect to the average brightness of the other separate area because the high-frequency noise largely affects the average brightness. In addition, since the uneven area cannot be fixed, the uneven area may reside on the boundary of two adjacent areas. In this case, the influence by the noise is increased to prevent the effective detection of the uneven area.

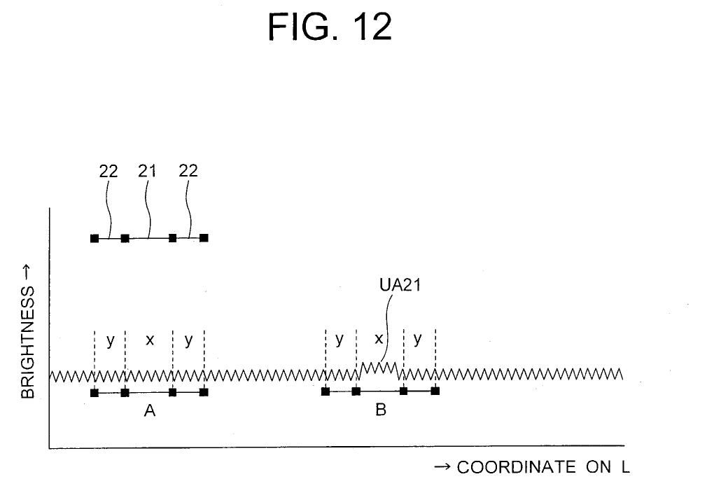

On the other hand, the emphasized imaged profile obtained by emphasizing the profile of FIG. 11B by using the image data processing unit of the present embodiment effectively detects the uneven area UA2. FIG. 12 shows, similarly to FIG. 9, the way of the present embodiment used for detecting the uneven area UA2 from the profile of FIG. 11B. At the location A, there is substantially no significant difference between the average brightness of the central area x and the average brightness of the peripheral area y because the width of the noise is significantly smaller than the central area x and cancelled by averaging the brightness of the pixels in each area x or y. On the other hand, at the location B where projection UA21 resides, the projection UA21 provides a larger difference between the average brightness of the central area x and the average brightness of the peripheral area y because the projection UA21 resides in the central area x. That is, the difference is larger at the location B than at the location A.

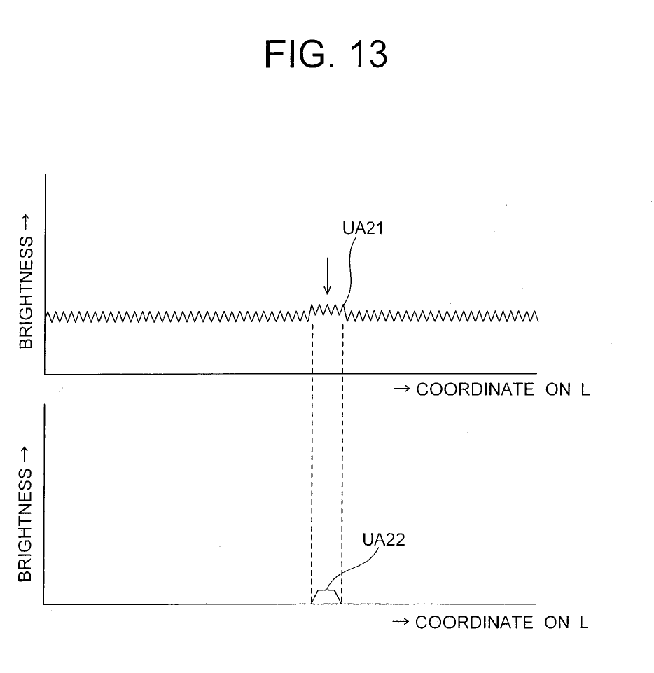

In addition, in the vicinity of location B wherein the central area x includes a portion of the projection UA21, the difference is larger than at the location A, i.e., normal area. FIG. 13 shows the profile of the line data shown in FIG. 11B and the profile of emphasized imaged data of the line data having a projection UA22, respectively.

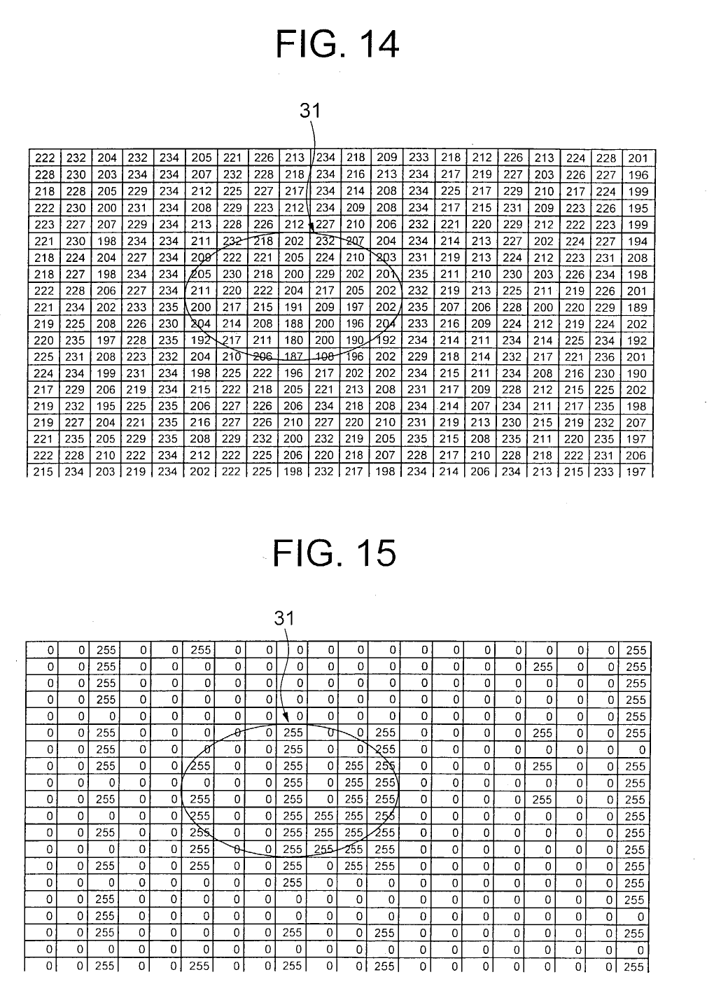

With reference to FIGS. 14 to 17, a concrete example of data processing by the conventional technique and the image data processing unit 50 will be described hereinafter. FIG. 14 shows the brightness data or gray levels of the two-dimensional image data quantized between 0 and 255 by the quantizer 52 from the image signal and stored in the two-dimensional image data memory 53. The data encircled by an ellipse 31 in FIG. 14 are the data of an uneven area. FIG. 15 shows data converted from the brightness data of FIG. 14 by the conventional technique encoding the brightness data by using a fixed threshold, although the data themselves are represented by the 0-255 gray level notation. In FIG. 15, the converted data shows a gray level, 255, for the uneven area 31 as well as other normal areas. Thus, an encoding processing using a fixed threshold does not allow the uneven area to be effectively detected from the gray levels.

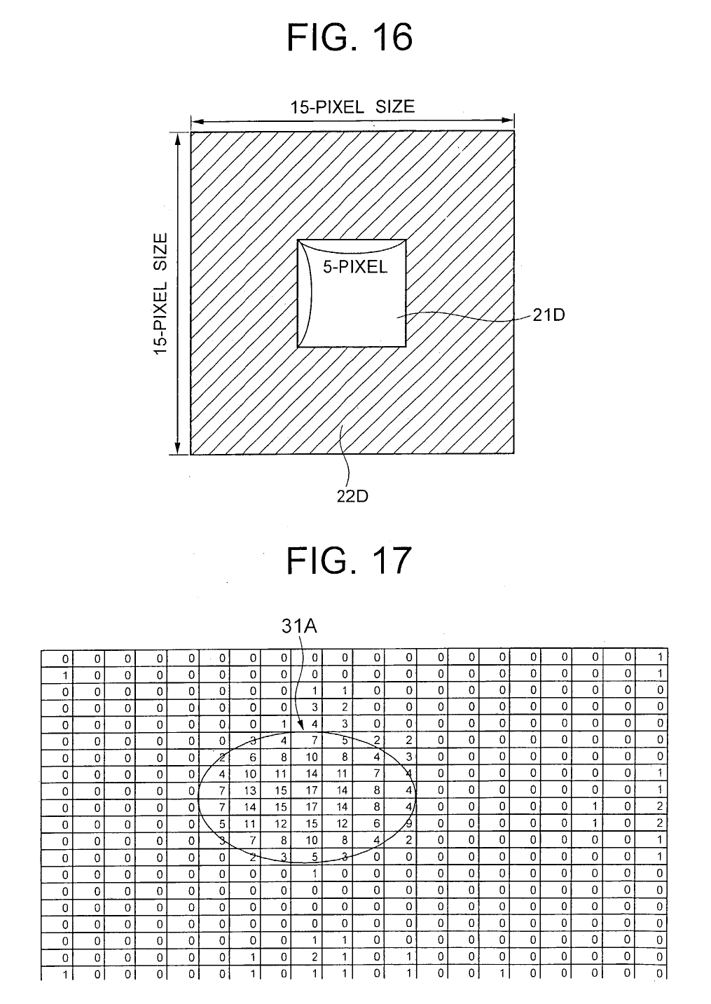

On the other hand, in the present embodiment, the area pattern selector 57 selects the combinational pattern shown in FIG. 16 including a square central area pattern 211D having a 5×5 pixel size and a square peripheral area pattern 22D encircling the central area pattern and having a 15×15 pixel size at the outer periphery thereof. The central area pattern 21D and the peripheral area pattern 22D are used for extracting the image brightness data from the two-dimensional image data shown in FIG. 14.

By tracing the two-dimensional image data by using the combinational pattern including the central area pattern 21D and the peripheral area pattern 22D, the average central brightness and the average peripheral brightness as well as the difference therebetween are calculated for each pixel of the two-dimensional image data, thereby creating emphasized image data. The resultant emphasized data including an emphasized uneven area 31A are shown in FIG. 17. It is assumed that a subject pixel P of the two-dimensional image data for which the emphasized image data is calculated corresponding to the lower right pixel of the central area pattern 21D has the coordinates (Xi, Yi), the average brightness of the central area for the pixel P(Xi, Yi) is M1(Xi, Yi), and the average brightness of the peripheral area for the pixel P(Xi, Yi) is M2(Xi, Yi). The emphasized image data Q(Xi, Yi) for the subject pixel P(Xi, Yi) is expressed and obtained by:

Q(Xi, Yi)=M1(Xi, Yi)−M2(Xi, Yi).

If M1(Xi, Yi)−M2(Xi, Yi)<0, then Q(Xi, Yi) is replaced by Q(Xi, Yi)=0.

The emphasized image data shown in FIG. 17 include the data encircled by the ellipse 31A and having higher values compared to the other areas which generally assume zero. Thus, it will be understood that the image data processing unit 50 of the present embodiment effectively emphasizes the image data in the uneven area substantially without being affected by the brightness change in the two-dimensional image data.

The uneven area extractor 62 extracts, as a candidate uneven area, a group of pixels each having an emphasized image data higher than a threshold. The threshold may be a fixed threshold. For example, the threshold may be a fixed value, 5, for encoding the emphasized image data exemplified in FIG. 17. In an alternative, the emphasized image data may be differentiated along the line (row) of the two-dimensional image data, and a group of pixels each having a higher differential value may be extracted as a contour of the candidate uneven area.

The unevenness measurement section 63 performs a labeling processing for the encoded data of the emphasized image data for the candidate uneven areas supplied from the uneven area extractor 62, thereby measuring the magnitude and size of each candidate uneven area as the degrees of unevenness. The degrees of unevenness may otherwise include a longer axis and/or shorter axis of the ellipse circumscribing the extracted candidate uneven area, or the longer side and/or the shorter side of the rectangle circumscribing the extracted candidate uneven area. The unevenness judgement section 64 then compares the degrees of unevenness against prescribed thresholds to thereby judge whether or not the candidate uneven area is a true uneven area.

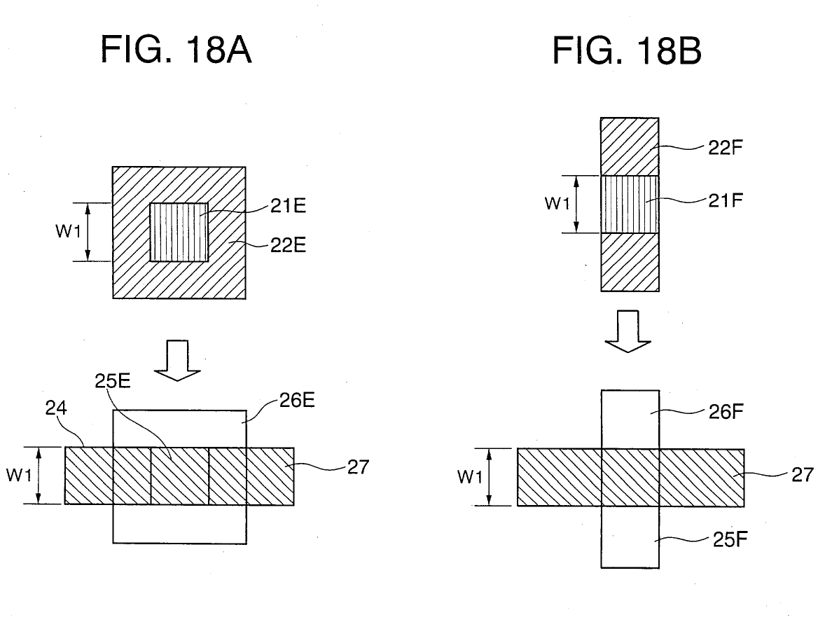

FIGS. 18A and 18B show specific examples of the relationship between the uneven area to be extracted and the combinational pattern including the central and peripheral area patterns and used for retrieving data the of pixels in the two-dimensional image data.

In general, the peripheral area pattern to be extracted by the peripheral area data extractor 59 should be determined based on the type of the uneven area to be extracted. For extracting an uneven area having a lateral stripe 27 from the two-dimensional image data as shown at the bottom of FIGS. 18A and 18B, it is preferable to use the combinational pattern including the peripheral area pattern 22F separated by the lateral stripe 27 as shown in FIG. 18B, not to use the combinational pattern shown in FIG. 18A.

More specifically, the combinational pattern shown in FIG. 18A is such that the central area pattern 21E has a square area having a side W1 equal to the width W1 of the lateral stripe 27, and the peripheral area pattern 22E encircles the central area pattern 21E, with the distance between the side of the central area pattern 21E and the corresponding side of the peripheral area pattern 22E being constant. Since this arrangement allows the lateral stripe 27 to pass through both the central and peripheral areas 25E and 26E, only a smaller difference is obtained between the average central brightness and the average peripheral brightness, whereby the unevenness is not effectively emphasized in the area of the lateral stripe 27 even if the shape and the size of the selected central area pattern 21E is adequate for the emphasis of the two-dimensional image pattern.

On the other hand, if the peripheral area pattern has a configuration shown in FIG. 18B, wherein the peripheral area pattern 22F is separated by the central area pattern 21F in the direction normal to the extending direction of the lateral stripe 27, the unevenness caused by the lateral stripe 27 is effectively emphasized. This is because the peripheral area 26F specified by the peripheral area pattern 22F does not include the lateral stripe 27 when the central area 25F specified by the central area pattern 21F includes the lateral stripe 27, to thereby provide a larger value for the average difference.

As described above, if it is desired that a stripe be emphasized in the emphasized image data, the peripheral area pattern should be separated in the direction normal to the extending direction of the stripe and disposed at both sides of the central area pattern, as shown in FIG. 18B.

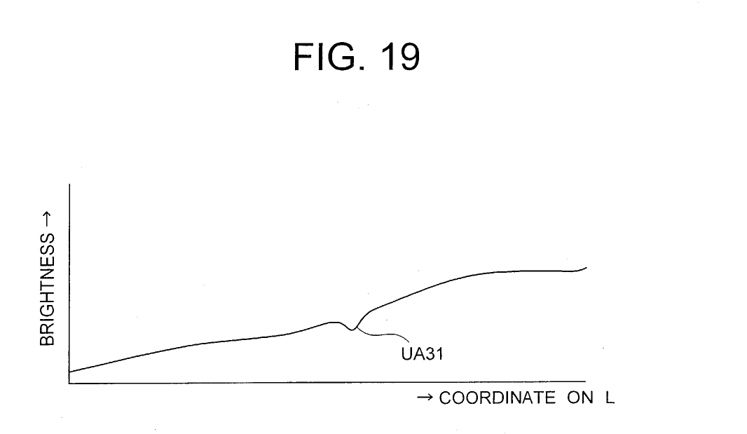

FIG. 19 shows an example wherein the profile of the line data has a depression UA31 due to the uneven area having a dark unevenness, contrary to the profile of FIG. 7B having a projection UA11 corresponding to a bright unevenness.

In the example of FIG. 19, it is assumed that a subject pixel P of the two-dimensional image data has the coordinates (Xi, Yi), the average brightness of the central area for the pixel P(Xi, Yi) is M1(Xi, Yi), and the average brightness of the peripheral area for the pixel P(Xi, Yi) is M2(Xi, Yi), similarly to the case of FIG. 17. In such a case, the difference Q(Xi, Yi) for the profile of FIG. 19 is represented and obtained by:

Q(Xi, Yi)=M2(Xi, Yi)−M1(Xi, Yi) (2).

In this case, if M2(Xi, Yi)−M1(Xi, Yi)<0, then Q(Xi, Yi) is replaced by Q(Xi, Yi)=0.

In the case of FIG. 19, the data is emphasized only for the case wherein the average brightness of the peripheral area is higher than the average brightness of the central area. If the relationship between the average brightness is revered, the emphasized data is replaced by zero, and only the dark uneven area is emphasized.

Instead of the subtractor 60, an adder may be used for the case wherein the central area pattern and the peripheral area pattern have an equal area. In this case, a difference is calculated between the sum of the brightness of the central area and the sum of the brightness of the peripheral are, and the difference between both the sums is divided by the equal area.

It is to be noted that the image data processing unit of the present invention can detect a more accurate uneven area based on the uneven area detected by the previous process by changing the or modifying the central and peripheral area patterns used in the previous process for emphasizing the two-dimensional image data.

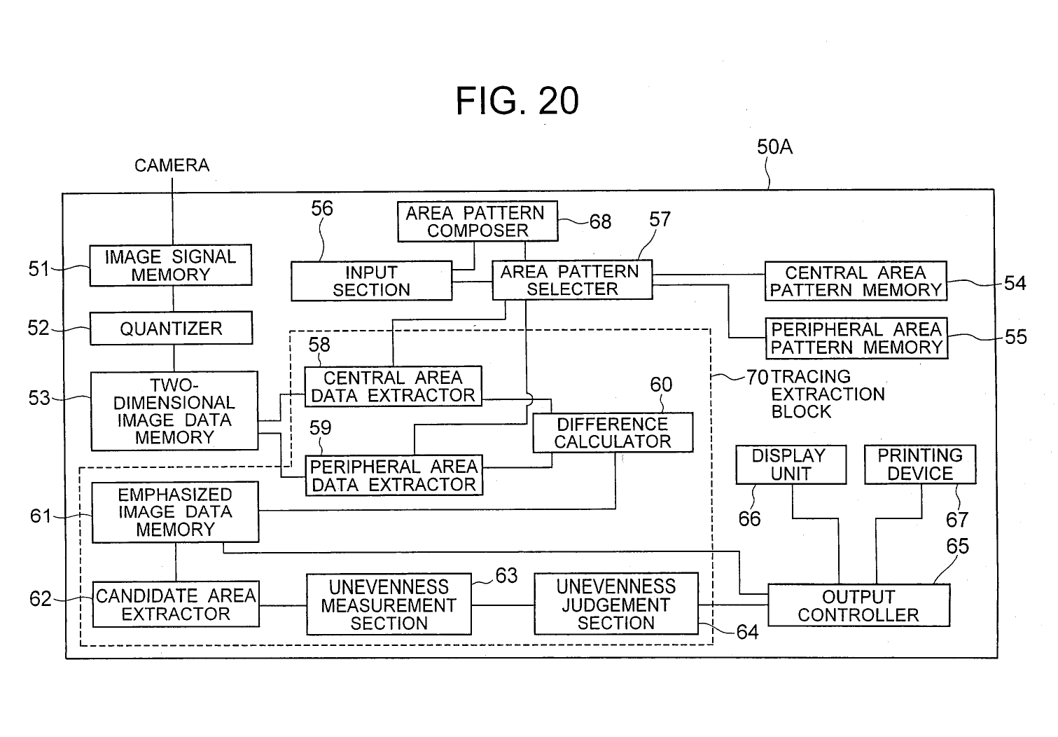

Referring to FIG. 20, an image data processing unit 50A according to a second embodiment of the present invention is similar to the image data processing unit 50 of FIG. 2, except that the image data processing unit 50A of the present embodiment includes an area pattern composer 68 in addition to the configuration of the image data processing unit 50. The area pattern composer 68 composes the central area pattern and/or the peripheral area pattern based on the instruction input through the input section 56, delivering the composed area patterns to the area pattern selector 57. The central and peripheral area patterns composed by the area pattern composer 68 may be stored in the central and peripheral area pattern memories 54 and 55, respectively.

The area pattern composer 68 receives through the input section 56 information of the shape and size of the uneven area to be extracted, quantizes the uneven area of the information received and creates the central area pattern based on the quantized uneven area. The area pattern composer 68 retrieves from the central area pattern memory 54 a central area pattern, if any, having a configuration similar to the configuration of the central area pattern thus created.

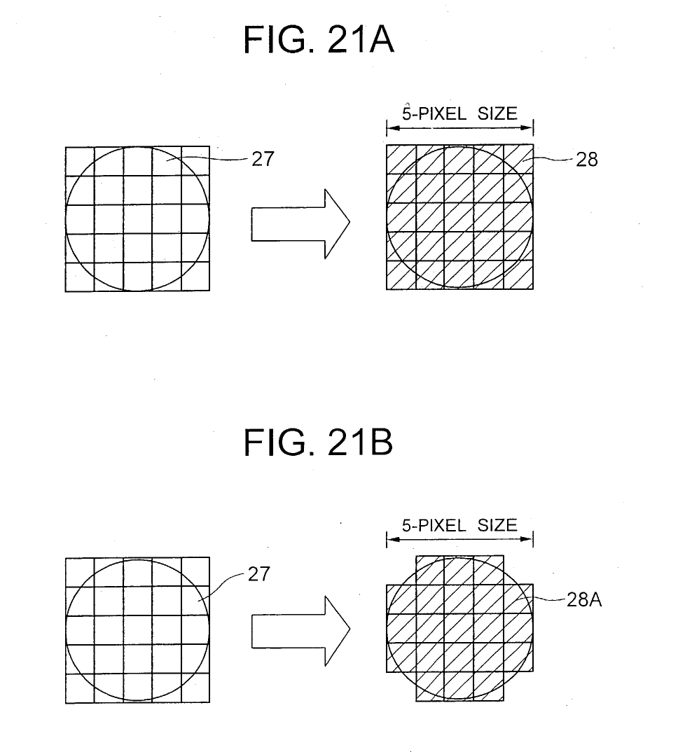

If it is desired to emphasize a circular uneven area such as shown at the left side of FIG. 21A, the circular area 27 may be approximated by the square area 28 having a 5×5 pixel area circumscribing the circular area, as shown at the right side of FIG. 21A. However, this approximation includes an error corresponding to the image brightness data of the area other than the circular area 27.

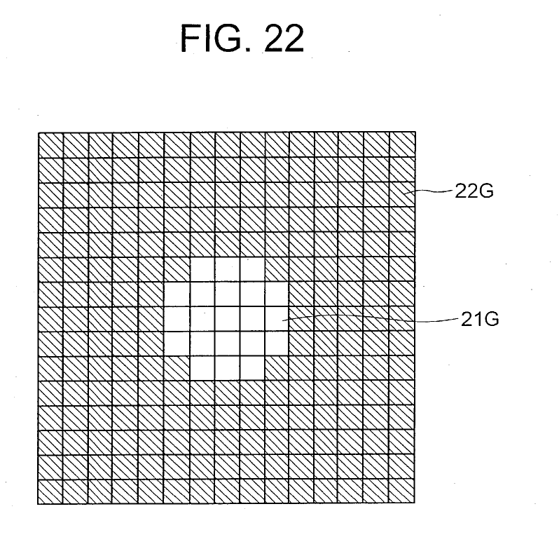

On the other hand, the area pattern composer in the present embodiment quantizes the circular uneven area 27 by using the pixel area, and approximates the quantized areas by a group of pixels 28A each overlapping the corresponding quantized area by 50% or more, as shown in FIG. 21B. This allows a more accurate approximation compared to the case of FIG. 21A. For the central area pattern 21G having the group of pixels 28A shown in FIG. 21B, a peripheral area pattern 22G having a 15×15 pixel size at the outer periphery thereof may be used, as shown in FIG. 22. The second embodiment allows creation and modification of the central area pattern more matched with the uneven area to be extracted, thereby effectively emphasizing the brightness of the desired uneven area.

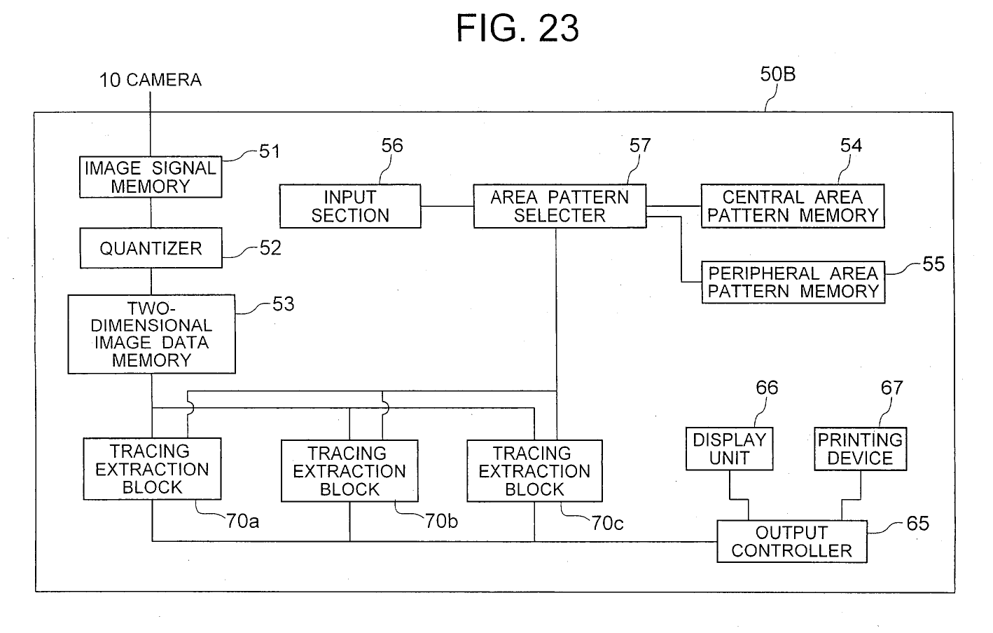

Referring to FIG. 23, the image data processing unit 50B according to a third embodiment of the present invention is similar to the image data processing unit 50 except that the image data processing unit 50B has a plurality of tracing extraction blocks 70a, 70b and 70c. The area pattern selector 57 selects a plurality of central area patterns and a plurality of peripheral area patterns each corresponding to one of a plurality of desired uneven areas to be emphasized, whereby each of the tracing extraction blocks 70a, 70b and 70c prepares emphasized image data by using a combinational pattern including a corresponding central area pattern and a corresponding peripheral area pattern for judgement of a desired uneven area.

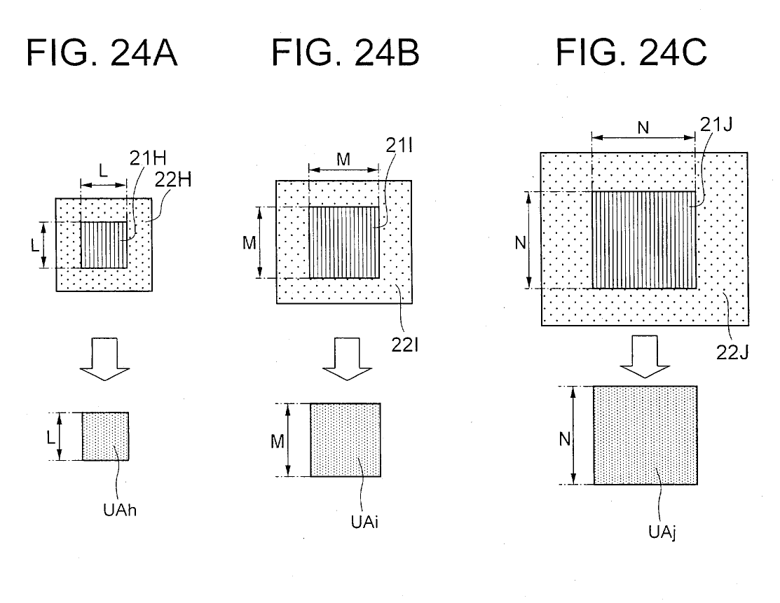

Referring to FIGS. 24A, 24B and 24C, when the area pattern selector 57 selects central area patterns 21H, 21I and 21J shown in FIGS. 24A, 24B and 24C having L×L, M×M and N×N pixel sizes, respectively, as well as peripheral area patterns 22H, 22I and 22J shown in these figures, the tracing extraction blocks 70a, 70b and 70c extract the image brightness data by using the central area patterns 21H, 21I and 21J having L×L, M×M and N×N pixel sizes, respectively, and the association peripheral area patterns 22H, 22I and 22J, thereby creating the emphasized image data.

The emphasized image data created by the tracing extraction blocks 70a, 70b and 70c emphasizes the image data in the uneven areas UAh, UAi and UAj, respectively, having corresponding areas and shown in these drawings.

In the third embodiment, the plurality of central area patterns 21H, 21I and 21J have a common shape and different sizes; however, the central area patterns 21H, 21I and 21J may have different shapes and/or different sizes. In addition, the number of types of the central area patterns 21H, 21I and 21J can be selected corresponding to the types of the uneven areas UAh, UAi and UAj to be detected. Moreover, a tracing extraction block may create a plurality of emphasized image data in series.

The third embodiment is used to obtain a plurality of sets of emphasized image data based on the different combinational patterns and allows a plurality of uneven areas having different types to be emphasized, thereby conducting stable and correct visual inspection of the object pattern.

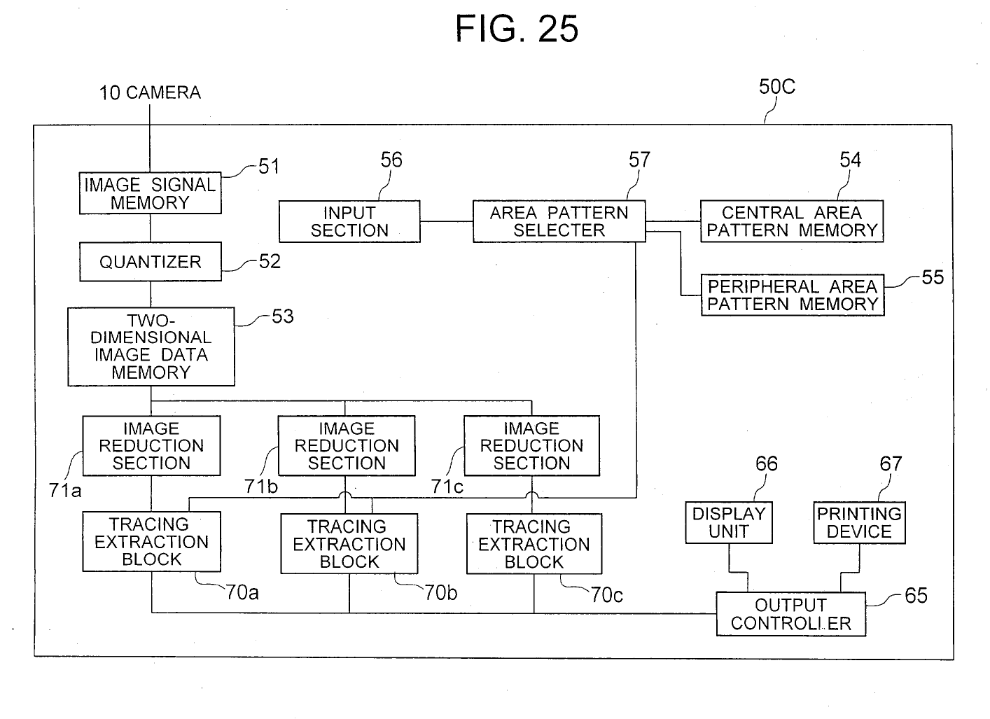

Referring to FIG. 25, an image data processing unit 50C according to a fourth embodiment of the present invention is similar to the image data processing unit 50B of FIG. 23 except that the image data processing unit 50C of the present embodiment includes image reduction sections 71a, 71b and 71c before the inputs of the tracing extraction blocks 70a, 70b and 70c, respectively. The image reduction section 71a, 71b and 71c reduce the two-dimensional image data stored in the two-dimensional image data memory 53 with different reduction ratios. Each of the tracing extraction blocks 70a, 70b and 70c magnifies the detected uneven area after the measurement thereof with the corresponding magnification ratio. In this configuration, the tracing extraction blocks 70a, 70b and 70c can emphasize the data of a plurality of uneven areas having a common shape and different sizes. The fourth embodiment can process the data at a higher rate compared to the third embodiment due to a reduced amount of processing.

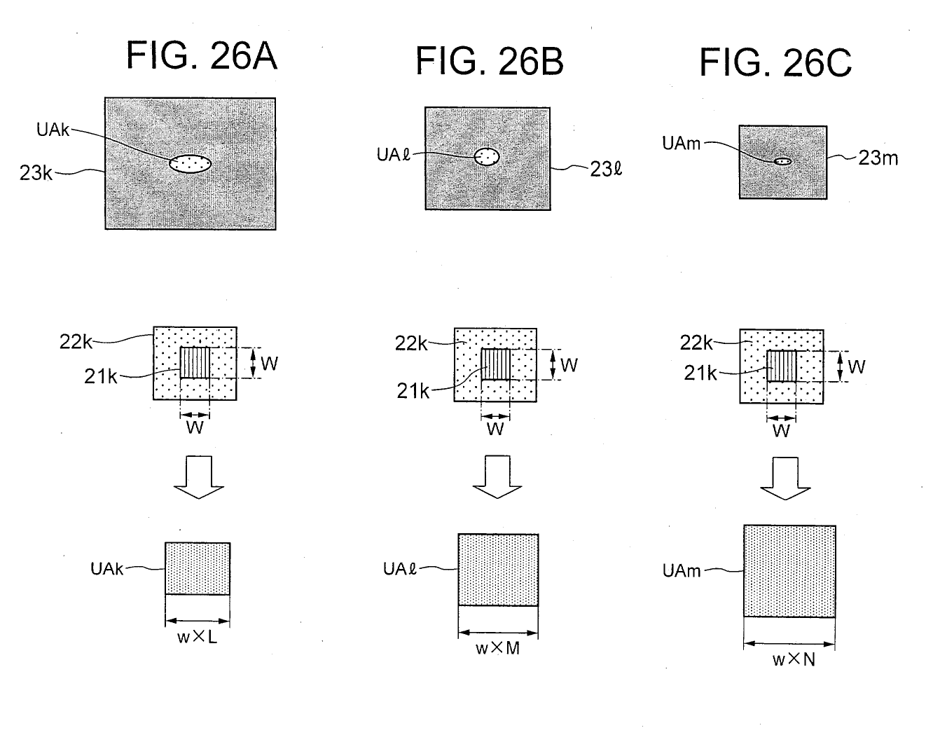

Referring to FIGS. 26A, 26B and 26C, the image reduction sections 71a, 71b and 71c reduce the two-dimensional image data stored in the two-dimensional image data memory 53 down to 1/L, 1/M and 1/N, respectively, of the original images including uneven areas UAk, UAl and UAm. The area pattern selector 57 selects a common central area pattern 21k having a square W×W pixel size and a corresponding peripheral area pattern 22k for the tracing extraction blocks 70a, 70b and 70c.

The tracing extraction blocks 70a, 70b and 70c emphasize therein the reduced uneven area having a W×W pixel size in the reduced image data 23k, 23l and 23m. The unevenness measurement sections 63 in the tracing extraction blocks 70a magnifies the reduced uneven areas 23k, 23l and 23m by L, M and N times, respectively, before measurement of the degree of the unevenness. Thus, the uneven areas UAk, UAl and UAm have W×L, W×M and W×N pixel sizes, as shown at the bottom of FIGS. 26A, 26B and 26C, respectively. The image reduction sections 71a, 71b and 71c may reduce the two-dimensional image data by the techniques of, for example, skipping at a constant pitch, averaging a plurality of divided areas, using a minimum or maximum value for a plurality of divided areas.

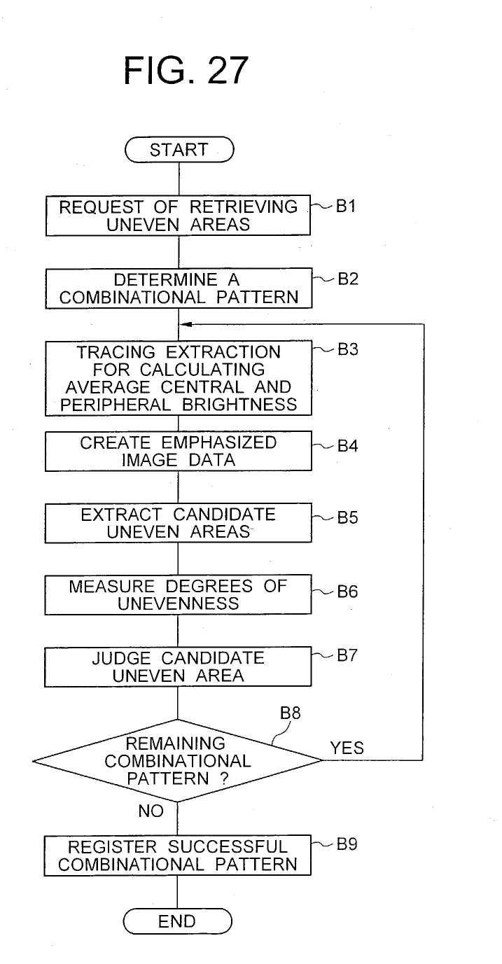

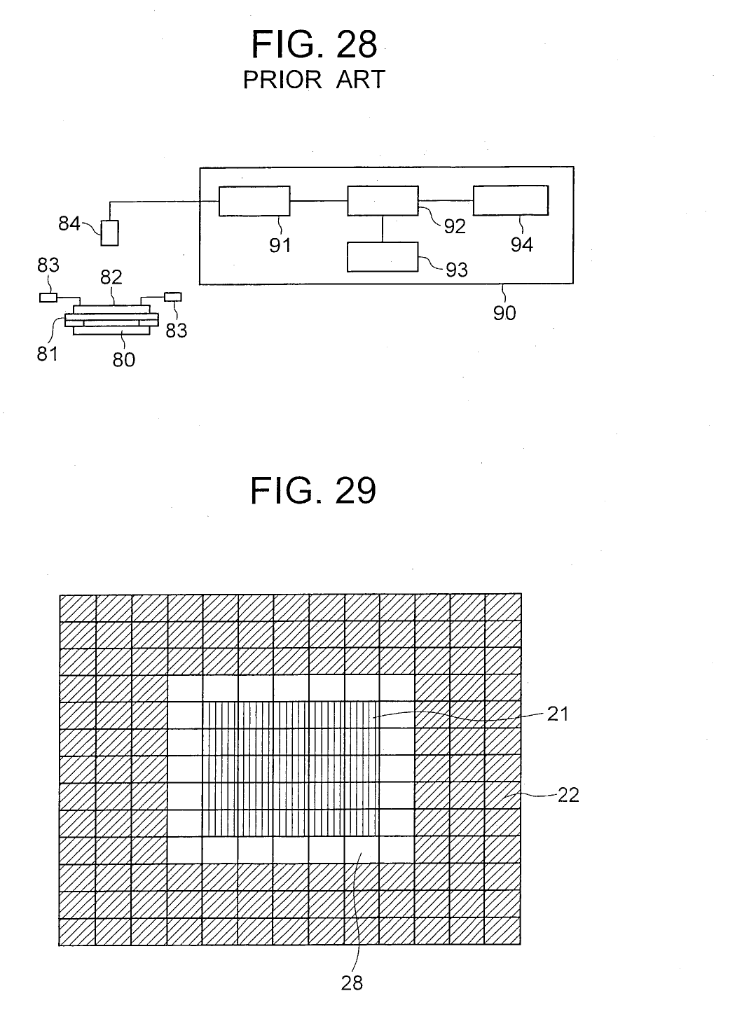

Referring to FIG. 27, there is shown a flowchart of processing by an image data processing unit according to a fifth embodiment of the present invention.

In the present embodiment, as in the case of previous embodiments, the central and peripheral area pattern memories 54 and 55 store therein a plurality of central area patterns and a plurality of peripheral area patterns, respectively, one of the central area patterns and one of peripheral area patterns being used as a retrieving combinational pattern for retrieving uneven areas having different types in the two-dimensional image pattern. The central area patterns of the retrieving combinational patterns have shapes and sizes similar to the shapes and sizes of the uneven areas existing in the two-dimensional image data.

The retrieving combinational patterns are used for emphasizing different uneven areas having different types, such as lateral stripes, longitudinal stripes, minor dot noise such as caused by stain or dust.

After an instruction for retrieving an uneven area is delivered (step B1), the area pattern selector 57 determines a combinational pattern including a central area pattern selected from the central area pattern memory 54 and a peripheral area pattern selected from the peripheral area pattern memory 55 (step B2).

The central area data extractor 58 and peripheral area data extractor 59 calculate the average central brightness and the average peripheral brightness by using the selected combinational pattern including the central and peripheral area patterns (step B3). The difference calculator 60 calculates differences between the average central brightness and the average peripheral brightness to create emphasized image data (step B4). The uneven area extractor 62 extracts a candidate uneven area, if any, having a difference of the emphasized image data higher than a threshold, delivering the information of the extracted candidate uneven area to the unevenness measurement section 63 after encoding the emphasized image data thereof. The unevenness measurement section 63 measures the degrees of unevenness of the candidate uneven area by using a labeling processing (step B6), delivering the results of the measurement to the unevenness judgement section 64. The unevenness judgement section 64 compares the degrees of unevenness, such as the size of the candidate uneven area and average difference thereof, against predetermined thresholds to thereby judge whether or not the candidate uneven area is a true uneven area (step B7).

It is judged in step B8 whether or not there is a remaining combinational pattern for retrieving candidate uneven areas in the two-dimensional image data. If all the retrieving combinational patterns are not yet used, the process returns to step B3 after selecting one of the remaining retrieving combinational patterns.

If it is judged in step B8 that all the retrieving combinational patterns are already used for retrieving candidate uneven areas, the unevenness judgement section 64 registers, in the area pattern selector 57, successful combinational patterns by which the candidate uneven area judged as a true uneven area by the unevenness judgement section 64 is actually retrieved (step B9). After the registry, the operator can use the successful combinational patterns registered in the area pattern selector 57 instead of selecting each of the central and peripheral area patterns separately.

There is a higher probability that the object patterns such as displayed on the display units fabricated on a single product line include uneven areas having common shape and size. On the other hand, in a new type of products, the shape and size of the uneven area are not known. It is thus preferable to use the image data processing unit of the fifth embodiment in the case of detecting the shape and size of the uneven areas in the new type of products. After the shapes and sizes of the probable uneven areas are found by using specific combinational patterns, the specific retrieving combinational patterns are used for the subsequent products of the same type for improving the accuracy of the visual inspection.

Referring to FIG. 29, there is shown an example wherein the central area pattern 21 is separated from the peripheral area pattern 22 with a gap 28 of single pixel size disposed therebetween. Although the central area pattern 21 and the peripheral area pattern 22 are disposed without a gap therebetween in the above embodiments, the gap 28 such as shown in FIG. 29 may be disposed therebetween. The gap 28 may be disposed so long as the extracted data for the uneven area are not substantially affected by the background. It is preferable that the gap 28 be equal to or less than half the width of the central area pattern 21.

Comparing the data obtained from the case of the presence of the gap 28 shown in FIG. 29 against the data obtained for the case of the absence of the gap such as shown in FIG. 16, there is substantially no difference therebetween with respect to the average difference between the average central brightness and the average peripheral brightness, although the former has a minor deficiency of data therein.

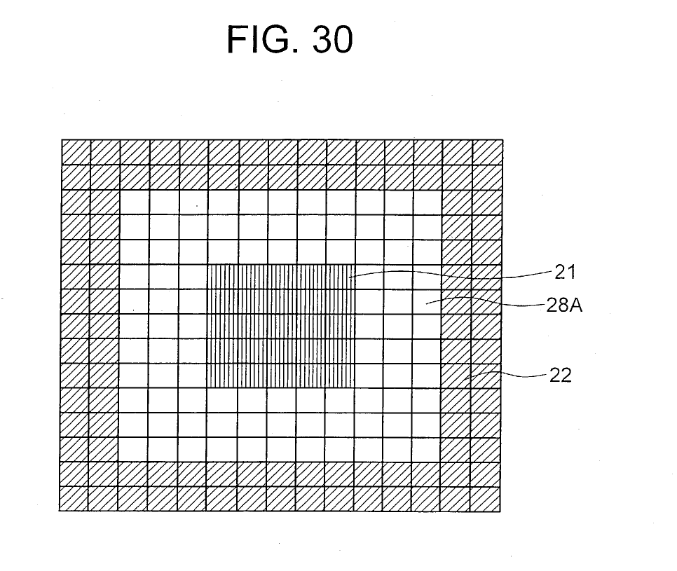

FIG. 30 shows another example of the gap wherein the gap 28A disposed between the central area pattern 21 and the peripheral area pattern 22 has a 3-pixel width and greater than half the width of the central area pattern 21. In this case, data for obtaining the average brightness may be insufficient for the peripheral area pattern 22 whereby there is a possibility that the average difference may be too large.

Since the above embodiments are described only for examples, the present invention is not limited to the above embodiments and various modifications or alterations can be easily made therefrom by those skilled in the art without departing from the scope of the present invention.

What is claimed is:

1. An image data processing unit comprising:
a central area data extractor for tracing two-dimensional imaged data to consecutively extract brightness of a plurality of pixels in a central area specified by a central area pattern and to obtain central brightness data:
a peripheral area data extractor for tracing the two-dimensional image data to consecutively extract brightness of a plurality of pixels in a peripheral area specified by a peripheral area pattern and to obtain peripheral brightness data, said peripheral area being juxtaposed with said central area in the two-dimensional image data; and
a difference calculator for calculating difference data between said central brightness data and corresponding said peripheral brightness data to thereby obtain emphasized two-dimensional image data.

2. The image data processing unit according to claim 1, further comprising an unevenness detection section for detecting an uneven area in the two-dimensional image data based on said emphasized two-dimensional image data.

3. The image data processing unit according to claim 2, wherein said unevenness detection section comprises a candidate area extractor for extracting a candidate uneven area based on said emphasized two-dimensional image data, an unevenness measurement section for measuring a degree of unevenness of said candidate uneven area, and an unevenness judgement section for judging based on said degree of unevenness whether or not said candidate uneven area is a true uneven area.

4. The image data processing unit according to claim 1, wherein said central area data extractor calculates, as said central brightness data, average brightness of pixels in said central area, and said peripheral area data extractor calculates, as said central brightness data, average brightness of pixels in said central area.

5. The image data processing unit according to claim 1, wherein said difference calculator either subtracts said peripheral brightness data from corresponding said central brightness data or subtracts said central brightness data from said peripheral brightness data.

6. The image data processing unit according to claim 1, further comprising a central area pattern memory for storing a plurality of central area patterns, and an area pattern selector for selecting one of said central area patterns to supply said selected one to said central area data extractor.

7. The image data processing unit according to claim 1, further comprising a peripheral area pattern memory for storing a plurality of peripheral area patterns, and an area pattern selector for selecting one of said peripheral area patterns to supply said selected one to said peripheral area data extractor.

8. The image data processing unit according to claim 1, further comprising an area pattern composer for composing said central area pattern and/or said peripheral area pattern.

9. The image data processing unit according to claim 2, further comprising a quantizing unit for quantizing data of an uneven area to be extracted to create quantized data, wherein said pattern area composer composes said central area pattern based on said quantized data.

10. The image data processing unit according to claim 1, further comprising a pattern area selector for selecting a plurality of said central area patterns having different shapes and/or different sizes and a plurality of peripheral area patterns having different shapes and/or different sizes, wherein said central area pattern extractor obtains a plurality of sets of central brightness data based on said plurality of central area patterns, said peripheral area pattern extractor obtains a plurality of sets of peripheral brightness data based on said plurality of peripheral area patterns, and said difference calculator obtains a plurality of sets of emphasized two-dimensional image data based on said plurality of sets of central area data and said plurality of sets of peripheral area data.

11. The image data processing unit according to claim 1, further comprising an image data reduction unit for reducing the two-dimensional image data with a plurality of reduction ratios to convert the two-dimensional image data into a plurality of reduced sets of two-dimensional image data, wherein said central area data extractor extracts data of the pixels in said central area in each of said reduced sets of two-dimensional image data and specified by a common central area pattern, and said peripheral area data extractor extracts data of the pixels in said peripheral area in each of said reduced sets of two-dimensional image data and specified by a common peripheral area pattern.

12. The image data processing unit according to claim 1, further comprising a combinational pattern memory for storing a combination of said central area pattern and a peripheral area pattern, said combinational pattern allowing said unevenness detection section to successfully detect an uneven area.

13. A method for processing two-dimensional image data, comprising the steps of;
tracing the two-dimensional imaged data to consecutively extract brightness of a plurality of pixels in a central area specified by a central area pattern and obtain central brightness data:
tracing the two-dimensional image data to consecutively extract brightness of a plurality of pixels in a peripheral area specified by a peripheral area pattern and obtain peripheral brightness data, said peripheral area being juxtaposed with said central area in the two-dimensional image data; and
calculating difference data between said central brightness data and corresponding said peripheral brightness data to thereby obtain emphasized two-dimensional image data.

14. The method according to claim 13, further comprising the step of detecting an uneven area in the two-dimensional image data based on said emphasized two-dimensional image data.

15. The method according to claim 14, wherein said uneven area detecting step comprises the steps of extracting a candidate uneven area based on said emphasized two-dimensional image data, measuring a degree of unevenness of said candidate uneven area, and judging based on said degree of unevenness whether or not said candidate uneven area is a true uneven area.

16. The method according to claim 13, wherein said central area data extracting step calculates, as said central brightness data, average brightness of pixels in said central area, and said peripheral area data extracting step calculates, as said central brightness data, average brightness of pixels in said central area pattern.

17. The method according to claim 13, wherein said difference calculating step either subtracts said peripheral brightness data from corresponding said central brightness data or subtracts said central brightness data from said peripheral brightness data.

18. The method according to claim 13, wherein said central area pattern is selected from a plurality of central area patterns stored in a first memory, and said peripheral area pattern is selected from a plurality of peripheral area patterns stored in a second memory.

19. The method according to claim 13, further comprising the step of composing said central area pattern and/or said peripheral area pattern.

20. The method according to claim 19, further comprising the step of quantizing data of an uneven area to be extracted to create quantized data, wherein said a pattern area composer composes said central area pattern based on said quantized data.

21. The method according to claim 13, further comprising the step of selecting a plurality of said central area patterns having different shapes and/or different sizes and a plurality of peripheral area patterns having different shapes and/or different sizes, wherein said tracing step for obtaining central brightness data obtains a plurality of sets of central brightness data based on said plurality of central area patterns, said tracing step for obtaining peripheral brightness data obtains a plurality of sets of peripheral brightness data based on said plurality of peripheral area patterns, and said difference calculating step obtains a plurality of sets of emphasized two-dimensional image data based on said plurality of sets of central area data and said plurality of sets of peripheral area data.

22. The method according to claim 13, further comprising the step of reducing the two-dimensional image data with a plurality of reduction ratios to convert the two-dimensional image data into a plurality of reduced sets of two-dimensional image data, wherein said central area data extracting step extracts brightness of the pixels in said central area in each of said reduced sets of two-dimensional image data and specified by a common central area pattern, and said peripheral area data extracting step extracts brightness of the pixels in said peripheral area in each of said reduced sets of two-dimensional image data and specified by a common peripheral area pattern.

23. The method according to claim 13, further comprising the step of storing a combinational pattern including said central area pattern and a peripheral area pattern, said combinational pattern allowing said unevenness detection step to successfully detect an uneven area.

24. A storage device for storing a program defining the method according to claim 13.
